(19) United States
(12) Patent Application Publication
(10) Pub. No.: US 2011/0172357 A1
(43) Pub. Date: Jul. 14, 2011

(54) COMPOSITION FOR FORMING SUBSTRATE, AND PREPREG AND SUBSTRATE USING THE SAME

(76) Inventors: Keun Yong LEE, Gyunggi-do (KR); Jun Rok Oh, Seoul (KR); Jin Seok Moon, Gyunggi-do (KR)

(21) Appl. No.: 12/710,132

(22) Filed: Feb. 22, 2010

(30) Foreign Application Priority Data
Jan. 8, 2010 (KR) 10-2010-0001811

(51) Int. Cl. C08L 63/00; C08G 65/22

(52) U.S. Cl. 524/612; 528/402

(57) ABSTRACT

Disclosed is a composition for forming a substrate, which includes a matrix resin including an epoxy resin and a fluoroepoxy compound introduced into the main chain of the epoxy resin. A prepreg and a substrate using the composition for forming a substrate are also provided.

### CROSS REFERENCE TO RELATED APPLICATION

This application claims the benefit of Korean Patent Application No. 10-2010-0001811, filed Jan. 8, 2010, entitled “Composition for forming substrate, and prepreg and substrate using the same”, which is hereby incorporated by reference in its entirety into this application.

### BACKGROUND OF THE INVENTION

1. Technical Field

The present invention relates to a composition for forming a substrate, and a prepreg and a substrate using the same.

2. Description of the Related Art

Alongside the advancement of electronic devices, the demand in a printed circuit board that is reduced in weight, thickness and size is increasing day by day. In order to meet such demand, a wiring pattern of a printed circuit board should become further complicated and dense. Thus, electrical, thermal, or mechanical stability required for a substrate is regarded as important. In particular, dimensional change by heat (e.g., coefficient of thermal expansion (CTE)) is one of the important factors determining the reliability of a substrate to be manufactured.

In addition, as high technology is being advanced, the frequency range used in information communication equipment is further increased. Particularly, high-speed wireless communication equipment is being used in the frequency range as high as tens of GHz.

Conventionally an insulating layer of a substrate is mainly made of epoxy. The CTE of epoxy is about 70˜100 ppm/° C., and the dielectric constant thereof is about 4.0 or more. However, the use of epoxy as the insulating material of the printed circuit board makes it impossible to manufacture a printed circuit board adapted for the high-speed and high-frequency range, in which constituent layers of the printed circuit board should be slimmer and the circuit width narrower. A polymer material that functions as an insulating material of a printed circuit board adapted for the high-speed and high-frequency range should have a low dielectric constant, but an insulating material including epoxy has a to comparatively high dielectric constant of about 4.0 or more, which causes interference in signal transmission of the circuit in the high-speed circuit and high-frequency range, undesirably increasing signal loss.

With the goal of solving such problems, glass cloth is impregnated with polytetrafluoroethylene (PTFE) powder having low dielectric loss and may thus be used as an insulating material of a printed circuit board. Although PTFE has superior electrical properties and high corrosion resistance in solvents, the insulating material of the printed circuit board manufactured by the above method is disadvantageous because the mechanical properties are deteriorated and the force of adhesion to copper foil serving as a circuit layer is reduced, and also because it is difficult to obtain uniform dispersion of the PTFE powder undesirably causing a partial difference in the dielectric constant of the substrate which results in dielectric loss or poor wave transmission, and is thus inappropriate for use as a material of a printed circuit board.

Therefore, the development of a material of a substrate having superior electrical properties while satisfying thermal and mechanical properties required to form an IC pattern which becomes slimmer and highly dense is urgently required.

### SUMMARY OF THE INVENTION

Leading to the present invention, intensive and thorough research carried out by the present inventors aiming to solve the problems encountered in the related art, resulted in the finding that a main chain of epoxy resin widely used as an insulating material of a printed circuit board may be reacted with a fluoroepoxy compound containing a fluorine component thus preparing a covalent-bond compound which is then used as a matrix resin, thereby obtaining an insulating material composition for a substrate having superior thermal and mechanical stability and high electrical properties.

Accordingly, the present invention is intended to provide a composition for forming a substrate having superior thermal and mechanical properties, and a prepreg and a substrate using the same.

Also the present invention is intended to provide a composition for forming a substrate having superior electrical properties, and a prepreg and a substrate using the same.

An aspect of the present invention provides a composition for forming a substrate, including a matrix resin composed of an epoxy resin and a fluoroepoxy compound introduced into the main chain of the epoxy resin.

In this aspect, the fluoroepoxy compound may be introduced into the main chain of the epoxy resin through a curing reaction.

In this aspect, the fluoroepoxy compound may have a reactive functional group which participates in a curing reaction, the reactive functional group being one or more selected from the group consisting of —COOH, —OH, —NH₂, and —Cl.

In this aspect, the fluoroepoxy compound may be one or more selected from the group consisting of compounds represented by Formulas 1 to 4 below:

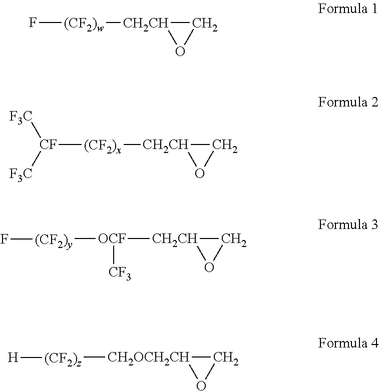

wherein w, x, y and z each are an integer ranging from 1 to 10.

In this aspect, the matrix resin may be obtained by reacting 100 parts by weight of the epoxy resin with 10˜200 parts by weight of the fluoroepoxy compound.

In this aspect, the composition may further include an inorganic filler which is in an amount of 5˜30 wt %.

Another aspect of the present invention provides a prepreg manufactured using the composition for forming a substrate.

A further aspect of the present invention provides a substrate manufactured using the composition for forming a substrate.

### BRIEF DESCRIPTION OF THE DRAWING

The features and advantages of the present invention will be more clearly understood from the following detailed description taken in conjunction with the accompanying drawings, in which:

FIG. 1 schematically shows a matrix resin of a composition for forming a substrate according to the present invention.

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

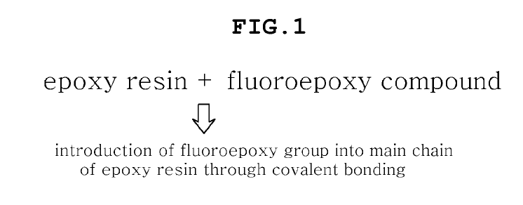

FIG. 1 schematically shows a matrix resin of a composition for forming a substrate according to the present invention.

As shown in FIG. 1, the composition for forming a substrate according to the present invention includes a matrix resin obtained by subjecting an epoxy resin and a fluoroepoxy compound to covalent-bond reaction, specifically, a covalent-bond compound in which a fluoroepoxy group is introduced into the main chain of the epoxy resin through a curing reaction.

Unlike a conventional insulating material of a printed circuit board composed of a typical epoxy resin and PTFE powder which are mixed together, in the present invention, an epoxy resin is used thus imparting superior properties of a conventional insulating material of a printed circuit board, and a fluoroepoxy compound is used which has a fluorine component able to achieve a low dielectric constant and an epoxide group able to form a covalent bond with the epoxy resin.

The epoxy resin used in the present invention is not particularly limited as long as it is known in the art, and an example thereof may include an epoxy resin represented by Formula 5 below.

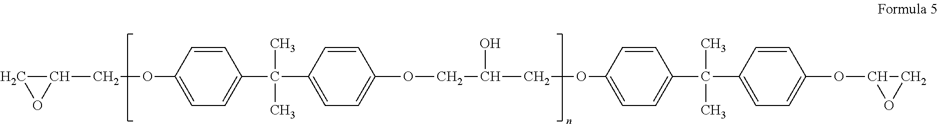

The fluoroepoxy compound used in the present invention participates in the curing reaction of the epoxy resin so as to be introduced into the main chain of the epoxy resin matrix through covalent bonding, thus attaining low dielectric constant properties based on the fluorine composition while imparting intrinsic thermal and mechanical properties of the epoxy resin.

The fluoroepoxy compound includes an epoxide structure at the end thereof, and may further include a reactive functional group as an additional functional group able to participate in the curing reaction. This reactive functional group is not particularly limited as long as it is known as a reactive functional group able to participate in a curing reaction in the art, and examples thereof may include —COOH, —OH, —NH₂ and/or —Cl.

The fluoroepoxy compound may include but is not limited to one or more selected from among compounds represented by Formulas 1 to 4 below.

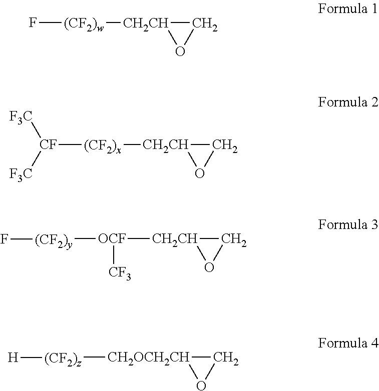

In Formulas 1 to 4, w, x, y and z each are an integer ranging from 1 to 10.

As such, the fluoroepoxy compound may be used in an amount of 10˜200 parts by weight, particularly favored being 20˜100 parts by weight, based on 100 parts by weight of the epoxy resin, in order to accomplish desired electrical properties versus efficiency.

Upon reaction between the epoxy resin and the fluoroepoxy resin, the reaction efficiency may be maximized using a curing agent or a curing accelerator in the presence of a solvent typically known in the art.

The composition for forming a substrate according to the present invention may include, in addition to the above matrix resin, one or more other insulating resins typically known in the art, and may further include an inorganic filler in a small amount, in particular in an amount of 5-30 wt %, in order to further increase thermal, mechanical and electrical properties, as necessary.

The composition for forming a substrate according to the present invention may be subjected to solvent casting, thus facilitating the impregnation of glass cloth or the like.

The composition for forming a substrate according to the present invention may further include one or more additives selected from among a filler, a softener, a plasticizer, a lubricant, an antistatic agent, a coloring agent, an antioxidant, a thermal stabilizer, a light stabilizer, and a UV absorbent, as necessary. Examples of the filler may include organic filler such as PTFE resin powder, epoxy resin powder, melamine resin powder, urea resin powder, benzoguanamine resin powder and styrene resin, and inorganic filler such as silica, alumina, titanium oxide, zirconia, kaolin, calcium carbonate and calcium phosphate.

The composition for forming a substrate according to the present invention has high strength of adhesion to copper foil and exhibits high heat resistance, low expansiveness and superior mechanical properties, and may thus be used as a good packaging material. Also, the composition for forming a substrate according to the present invention may be formed into a substrate or may form a varnish for impregnation or coating. Also, the composition according to the present invention may be applied to a printed circuit board, each layer of a multilayer substrate, a copper clad laminate (e.g., resin coated copper, copper clad to laminate), or a TAB film, but the present invention is not limited thereto.

Also, the composition according to the present invention may be cast on a substrate and then cured and thus may serve as a material of a substrate or the like.

The composition for forming a substrate according to the present invention may be used to impregnate nonwoven glass fabric thus manufacturing a prepreg, or may be manufactured into a build-up film and thus may be used as an insulating material of a printed circuit board.

In addition, a prepreg may be manufactured by impregnating a reinforcement with a composition, in particular, impregnating a reinforcement with the composition for forming a substrate according to the present invention and curing it, thus forming a sheet. The reinforcement is not particularly limited, and examples thereof may include glass cloth, alumina glass cloth, nonwoven glass fabric, nonwoven cellulose fabric, carbon cloth, and polymer cloth. The method of impregnating the reinforcement with the composition for forming a substrate may include dip coating, roll-to-roll coating, and other typical impregnation methods.

In addition, a substrate may be manufactured using the composition for forming a substrate according to the present invention. The substrate is not particularly limited, and examples thereof may include each layer of a multilayer substrate, a metal clad laminate, a printed circuit board and so on. Also, the substrate may be provided in the form of the prepreg being clad with metal foil.

The substrate may be of various types, and may be in film form. The film may be manufactured by forming the composition for forming a substrate according to the present invention into a thin film.

The substrate may be provided in the form of a metal clad laminate, other than the film form. As such, the metal foil may include for example copper foil or aluminum foil. The thickness of the metal foil may vary depending on the end uses, and may be generally to set to 5˜100 μm. The metal clad laminate may be manufactured into a printed circuit board by subjecting the metal foil thereof to circuit processing. Also, the metal clad laminate may be stacked on the surface of a printed laminate and processed, thus manufacturing a multilayer printed circuit board.

The metal clad laminate is not particularly limited, and examples thereof may include resin coated copper, copper clad laminate, etc.

A better understanding of the present invention may be obtained through the following examples which are set forth to illustrate, but are not to be construed as limiting the present invention.

### Comparative Example 1

Into a 100 ml flask equipped with a condenser and a stirrer, 20 g of bisphenol A type epoxy, 7.5 g of diaminodiphenyl methane (DDM) and 20 g of 2-methoxy ethanol (2-ME) were added, and stirred while gradually increasing the temperature to 90° C., so that epoxy and DDM were dissolved and mixed. While the temperature was maintained, the curing reaction was carried out for 2 hours, thus preparing a solution having a viscosity adequate for casting. This reaction solution was cast in the form of a film on the surface of PET and dried in an oven at 60° C. for 1 hour. Then, the well dried film was removed from the PET, and then completely cured in an oven at 190° C. for 2 hours.

### Comparative Example 2

Glass cloth (#1078) was impregnated with the polymer solution synthesized in Comparative example 1, thus manufacturing a prepreg.

### Example 1

Into a 100 ml flask equipped with a condenser and a stirrer, 20 g of bisphenol A type to epoxy, 9.5 g of DDM and 20 g of 2-ME were added, and stirred while gradually increasing the temperature to 90° C., so that epoxy and DDM were dissolved and mixed. After the epoxy and curing agent were completely dissolved, 8 ml of a fluoroepoxy compound of Formula 2 was added thereto. Then, while the temperature was maintained, the curing reaction was carried out for 2 hours, thus preparing a solution having a viscosity adequate for casting. This reaction solution was cast in the form of a film on the surface of PET and dried in an oven at 60° C. for 1 hour. Then, the well dried film was removed from the PET and then completely cured in an oven at 190° C. for 2 hours.

### Example 2

Glass cloth (#1078) was impregnated with the polymer solution synthesized in Example 1, thus manufacturing a prepreg.

The CTE of each of the films obtained in Comparative Example 1 and Example 1 was measured. The results are shown in Table 1 below. The CTE was measured at a heating rate of 10° C./min in a state of nitrogen being purged. The CTE was the mean value determined in the range of 50˜100° C. The dielectric constant of each of the prepregs manufactured in Comparative Example 2 and Example 2 was measured. The results are shown in Table 2 below.

TABLE 1

| | C. Ex. 1 | Ex. 1 |
|---|---|---|
| CTE (ppm/° C.) | 67.8 | 69.5 |

TABLE 2

| | C. Ex. 2 | Ex. 2 |
|---|---|---|
| Dielectric Constant | 4.3 | 3.5 |

As is apparent from Table 1, the film (Example 1) and the prepreg (Example 2), manufactured using the epoxy resin into which the fluoroepoxy compound is introduced according to the present invention, can be seen to exhibit equivalent CTE and lower dielectric constant compared to the film (Comparative Example 1) and the prepreg (Comparative Example 2) manufactured using conventional epoxy resin. Thus, the composition for forming a substrate according to the present invention is considered to manifest superior thermal, mechanical and electrical properties when used as an insulating material of a printed circuit board adapted for the high-speed circuit and high-frequency range.

As described hereinbefore, the present invention provides a composition for forming a substrate, and a prepreg and a substrate using the same. According to the present invention, the composition for forming a substrate includes a matrix resin composed of an epoxy resin and a fluorine compound having a low dielectric constant which is introduced into the main chain of the epoxy resin, so that a fluorine component is easily and uniformly dispersed in the matrix. Thus, the composition composed of epoxy resin and fluorine compound uniformly dispersed in the matrix has no partial difference in dielectric constant, and can be used as an insulating material of a printed circuit board adapted for the high-speed circuit and high-frequency range. Furthermore, because intrinsic thermal and mechanical properties of epoxy resin widely used as an insulating material of a printed circuit board are not greatly deteriorated, the composition according to the present invention can be provided as an insulating material of a printed circuit board able to exhibit considerably lower dielectric constant properties compared to conventional epoxy materials.

Although the embodiments of the present invention regarding the composition for forming a substrate, and the prepreg and the substrate using the same have been disclosed for illustrative purposes, those skilled in the art will appreciate that a variety of different to modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A composition for forming a substrate, comprising a matrix resin comprising an epoxy resin and a fluoroepoxy compound introduced into a main chain of the epoxy resin.

2. The composition as set forth in claim 1, wherein the fluoroepoxy compound is introduced into the main chain of the epoxy resin through a curing reaction.

3. The composition as set forth in claim 1, wherein the fluoroepoxy compound has a reactive functional group which participates in a curing reaction.

4. The composition as set forth in claim 3, wherein the reactive functional group is one or more selected from the group consisting of —COOH, —OH, —NH₂, and —Cl.

5. The composition as set forth in claim 1, wherein the fluoroepoxy compound is one or more selected from the group consisting of compounds represented by Formulas 1 to 4 below: 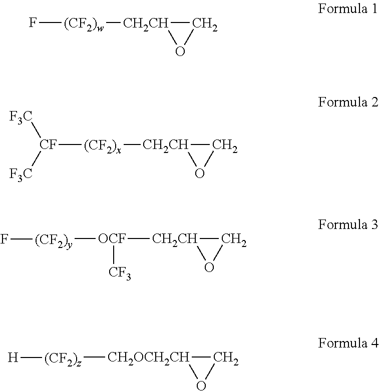
wherein w, x, y and z each are an integer ranging from 1 to 10.

6. The composition as set forth in claim 1, wherein the matrix resin is obtained by reacting 100 parts by weight of the epoxy resin with 10˜200 parts by weight of the fluoroepoxy compound.

7. The composition as set forth in claim 1, further comprising an inorganic filler.

8. The composition as set forth in claim 7, wherein the inorganic filler is used in an amount of 5˜30 wt %.

9. A prepreg manufactured using the composition for forming a substrate of claim 1.

10. A substrate manufactured using the composition for forming a substrate of claim 1.
